(19) United States
(12) Patent Application Publication
(10) Pub. No.: US 2025/0299251 A1
(43) Pub. Date: Sep. 25, 2025

(54) SYSTEMS AND METHODS FOR AUTOMATICALLY GENERATING AND PRESENTING STRUCTURED INSIGHT DATA

(71) Applicant: Wolters Kluwer Financial Services, Inc., Minneapolis, MN (US)

(72) Inventors: Abhishek Mittal, Clark, NJ (US); Rajiv Arora, Katy, TX (US); Saheb Chourasia, Fulshear, TX (US); Mukesh Agarwal, Pune (IN); Amit Gupta, Gurugram (IN); Rohan Girishchandra Pimprikar, Hoboken, NJ (US); Piyush Wadhwa, Pune (IN); Ashtik Mahapatra, Bhubaneswar (IN); Ashuvendra Pratap Singh, Edison, NJ (US); Varahala Raju Penumatsa, Vizianagaram (IN); Shunhuan Xu Morris, Friendswood, TX (US)

(73) Assignee: Wolters Kluwer Financial Services, Inc., Minneapolis, MN (US)

(21) Appl. No.: 18/609,685

(22) Filed: Mar. 19, 2024

(51) Int. Cl. G06Q 40/03; G06V 30/18

(52) U.S. Cl. CPC G06Q 40/03; G06V 30/18; G06V 2201/10

(57) ABSTRACT

Systems and methods for automated data extraction and analysis are disclosed. A search request is received from a user device. The search request is directed to a domain-specific database. The domain-specific database is searched based on the search request to identify at least one domain-specific document and a natural language processing (NLP) model is applied to extract textual data and metadata from the at least one domain-specific document. The textual data and the metadata is provided as inputs to at least one insight related machine learning model to generate structured insight data based on a set of taxonomies. Instructions are transmitted to a user device to cause the user device to display the structured insight data to the user.

### TECHNICAL FIELD

This application relates generally to data search and conversion and, more particularly, to systems and methods for automatically generating and presenting structured insight data in financial due diligence.

### BACKGROUND

In the current financial landscape, lenders often require thorough asset searches before loan approvals. Existing methods, typically manual and expert-driven, are not only time-consuming but also prone to inaccuracies. For instance, manual reviews of lien searches often overlook key legal subtleties, leading to incomplete risk assessments. As such, lenders are actively seeking ways to significantly reduce the timeline for reviewing lien filings while also reducing the risk of errors.

### SUMMARY

The embodiments described herein are directed to systems and methods for automatically utilizing advanced data parsing and artificial intelligence (AI) analysis to ensure comprehensive and accurate asset evaluation. Some embodiments aim at revolutionizing how financial institutions conduct asset evaluations. By leveraging machine learning algorithms and natural language processing, the disclosed system can automatically parse, tag, and generate insights from complex legal documents, such as lien filings. This automation not only speeds up the process significantly but also enhances the accuracy of insights, thus enabling more informed decision-making in lending scenarios.

In various embodiments, a system including a non-transitory memory configured to store instructions thereon and at least one processor is disclosed. The at least one processor is operatively coupled to the non-transitory memory and configured to read the instructions to: perform a search, based on a request from a user, for at least one legal document in a database; extract textual data and metadata from the at least one legal document; categorize, using a machine learning model, the textual data and the metadata to generate structured insight data based on a set of taxonomies; and transmit the structured insight data to the user.

In various embodiments, a computer-implemented method is disclosed. The computer-implemented method includes: performing a search, based on a request from a user, for at least one legal document in a database; extracting textual data and metadata from the at least one legal document; categorizing, using a machine learning model, the textual data and the metadata to generate structured insight data based on a set of taxonomies; and transmitting the structured insight data to the user.

In various embodiments, a non-transitory computer readable medium having instructions stored thereon is disclosed. The instructions, when executed by at least one processor, cause at least one device to perform operations including: performing a search, based on a request from a user, for at least one legal document in a database; extracting textual data and metadata from the at least one legal document; categorizing, using a machine learning model, the textual data and the metadata to generate structured insight data based on a set of taxonomies; and transmitting the structured insight data to the user.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for automatically generating and presenting structured insight data, in accordance with some embodiments of the present teaching;

FIG. 2 shows a block diagram of an insight generation computing device, in accordance with some embodiments of the present teaching;

FIG. 3 shows a block diagram illustrating various portions of a system for automatically generating and presenting structured insight data, in accordance with some embodiments of the present teaching;

FIG. 4 shows a block diagram illustrating various portions of an insight generation computing device, in accordance with some embodiments of the present teaching;

FIG. 5 illustrates a process for securing a loan based on a lien search, in accordance with some embodiments of the present teaching;

FIG. 6 illustrates exemplary tags output as insight data, in accordance with some embodiments of the present teaching;

FIG. 7 is a flowchart illustrating an exemplary method for automatically generating and presenting structured insight data, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Certain institutions (e.g., supplier finance programs, small business lenders, farm credits, etc.) may mitigate risk by conducting thorough search and due diligence reviews on sets of documents or filings, such as uniform commercial code (UCC) filings, before making final lending decisions. The present teaching discloses methods and systems for automatically generating and presenting structured insight data based on the search results.

In some embodiments, a disclosed system may improve an entity's search processing, for example, by taking millions of UCC lien filings, analyzing them with an artificial intelligence (AI) model, and providing entities actionable insights that may be used to make additional and/or downstream decisions, all in a small fraction of the time and cost it would take for the entities to do it themselves. In some embodiments, the AI model may be a machine learning model trained based on expert knowledge, to provide entities AI supported intelligence rather than merely searched documents.

In some embodiments, the disclosed system provides an AI-enabled solution configured to create data assets from targeted content to drive faster due diligence. For example, the system can automatically extract UCC collateral information from UCC filing's collateral descriptions, and apply user or industry specific taxonomies to tag and identify key information on collateral, such as whether there is a blanket lien, what is secured party position, etc.

The disclosed system can reduce cost, shorten turnaround time, decrease risk for users, while increasing overall scalability via order placement and insights delivery based on application programming interface (API). The API output may include an integration of search results, collateral tagging and advanced analytics to deliver risk intelligence for a lender to make a lending decision. In some embodiments, the insight data in the API output are structured and actionable such that a lender can make a lending decision directly based on the insight data.

The disclosed system saves time and expense by reducing third-party legal or in-house experts review times. The disclosed system can organize, tag, and analyze search results to provide intelligent inputs for users' risk decisions, rather than providing a data dump. The disclosed system provides a scalable platform to support multi-factor growth. The disclosed system utilizes optical character recognition (OCR), natural language processing (NLP), artificial intelligence (AI), feedback loops, rather than or in addition to human expert reviews, to produce accurate decision-making and reduce risk of decision errors. In some embodiments, the disclosed method can be realized with a single API call that is integrated into workflow and supporting systems.

Consider a scenario where a lender is evaluating a borrower's asset portfolio for a significant loan. The disclosed system can autonomously sift through thousands of UCC filings, extract pertinent data like filing dates, debtor information, and collateral descriptions. The system may then apply a predefined taxonomy, specific to the lending industry, to tag and categorize this data. For instance, if the system detects a “blanket lien” on a particular asset, a corresponding flag is generated for the lender's review, highlighting potential risks that might impact the loan decision.

In some embodiments, the disclosed systems and methods can be applied to generate structured insight data based on not only lien documents, but also any document (e.g. legal documents, transactional documents, technical documents, etc.) including complicated content that is difficult for an individual to digest without structured insight data.

Furthermore, in the following, various embodiments are described with respect to systems and methods for automatically generating and presenting structured insight. In some embodiments, a disclosed method includes: performing a search, based on a request from a user, for at least one legal document in a database; extracting textual data and metadata from the at least one legal document; determining a set of taxonomies based on the request; generating, using a machine learning model, a plurality of tags for the at least one legal document based on the set of taxonomies; generating structured insight data based on the textual data, the metadata and the plurality of tags; and transmitting the structured insight data to the user.

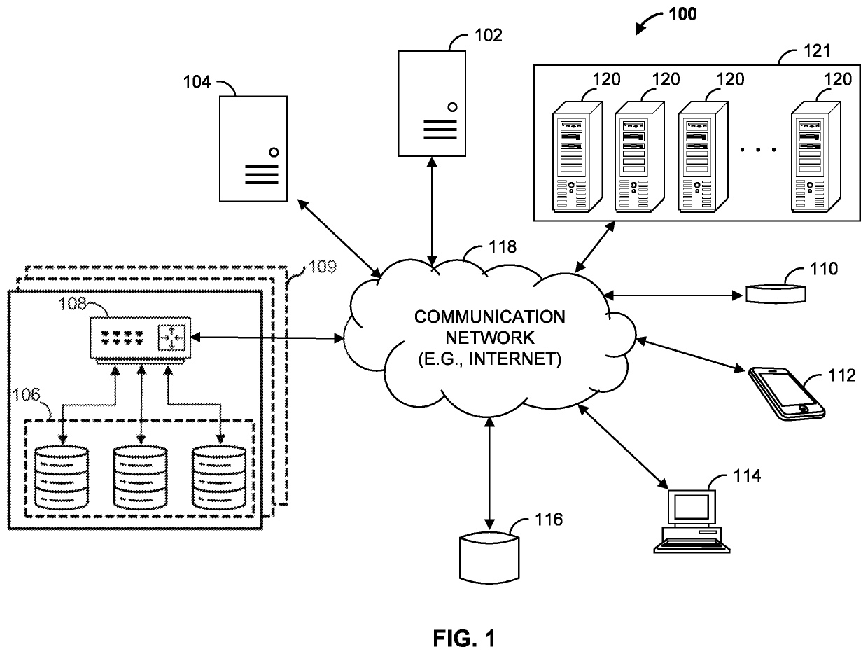

Turning to the drawings, FIG. 1 is a network environment 100 configured for automatically generating and presenting structured insight data, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an insight generation computing device 102, a server 104 (e.g., a web server or an application server), a cloud-based engine 121 including one or more processing devices 120, data center(s) 109, a database 116, and one or more user computing devices 110, 112, 114 operatively coupled over the network 118. The insight generation computing device 102, the server 104, the data center(s) 109, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the insight generation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the insight generation computing device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the server 104 hosts one or more websites or applications. In some examples, the insight generation computing device 102, the processing devices 120, and/or the server 104 are operated by a data service provider, and the multiple user computing devices 110, 112, 114 are operated by users of the service or application provided by the data service provider. In some examples, the processing devices 120 are operated by a third party (e.g., a cloud-computing provider).

Each of the data center(s) 109 is operably coupled to the communication network 118 via a router (or switch) 108 included therein. The data center 109 may include one or more databases 106 that are searchable. The data center(s) 109 can communicate with the insight generation computing device 102 over the communication network 118. The data center(s) 109 may send data to, and receive data from, the insight generation computing device 102. For example, the data center(s) 109 may transmit data identifying documents matching a query submitted by the insight generation computing device 102 to the insight generation computing device 102.

Although FIG. 1 illustrates three user computing devices 110, 112, 114, the network environment 100 can include any number of user computing devices 110, 112, 114. Similarly, the network environment 100 can include any number of the insight generation computing devices 102, the processing devices 120, the data centers 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website or API hosted by the server 104. The server 104 may capture user session data related to a customer's activity (e.g., interactions) on the website or API.

In some examples, a customer may operate one of the user computing devices 110, 112, 114 to access the website (or API) hosted by the server 104. The customer may view services provided on the website, and may click on some advertisements, for example. The website may capture these activities as user session data, and transmit the user session data to the insight generation computing device 102 over the communication network 118.

In some examples, the server 104 may transmit an insight generation request to the insight generation computing device 102. The insight generation request may be sent together with conditions and/or queries provided by a user (e.g., via API hosted by the data service provider), or a standalone insight generation request provided by a processing unit in response to the user's action on a website, e.g. clicking a button on the website, submitting a request on the website, etc.

In some examples, upon receiving the insight generation request, the insight generation computing device 102 may search for documents, matching the conditions and/or queries provided by the user, from one or more database(s) 106 in one or more data center(s) 109. Based on the search results from the one or more data center(s) 109, the insight generation computing device 102 can convert the unstructured document data in the search results to structured insight data that is actionable for the user.

In some examples, the insight generation computing device 102 may execute one or more models (e.g., programs or algorithms), such as a machine learning model, deep learning model, statistical model, etc., to generate the structured insight data. The insight generation computing device 102 may transmit the structured insight data (e.g. insights about a lien, a contract, a legal document, etc.) to the server 104 over the communication network 118, and the server 104 may display the structured insight data on the website or via API to users (e.g. supplier finance programs, business lenders) who are interested in these data.

In some embodiments, the insight generation computing device 102 is further operable to communicate with the database 116 over the communication network 118. For example, the insight generation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the insight generation computing device 102, in some examples, the database 116 can be a local storage device, such as a hard drive, a non-volatile memory, or a USB stick. The insight generation computing device 102 may store data received from the server 104 in the database 116. The insight generation computing device 102 may receive data from the data center(s) 109 and store them in the database 116. The insight generation computing device 102 may also store the structured insight data in the database 116.

In some examples, the insight generation computing device 102 generates training data for a plurality of models (e.g., machine learning models, deep learning models, statistical models, algorithms, etc.) based on: e.g. historical search data, historical insight data, historical user feedback data, etc. The insight generation computing device 102 trains the models based on their corresponding training data, and stores the models in a database, such as in the database 116 (e.g., a cloud storage).

The models, when executed by the insight generation computing device 102, allow the insight generation computing device 102 to generate insight data based on corresponding datasets. For example, the insight generation computing device 102 may obtain the models from the database 116. The insight generation computing device 102 may receive, in real-time from the server 104, an insight generation request identifying a request from a user for insights of some legal documents. In response to receiving the request, the insight generation computing device 102 may execute the models to generate insights for the legal documents to be displayed to the user.

In some examples, the insight generation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the insight generation computing device 102 may generate structured insight data to be displayed to a user.

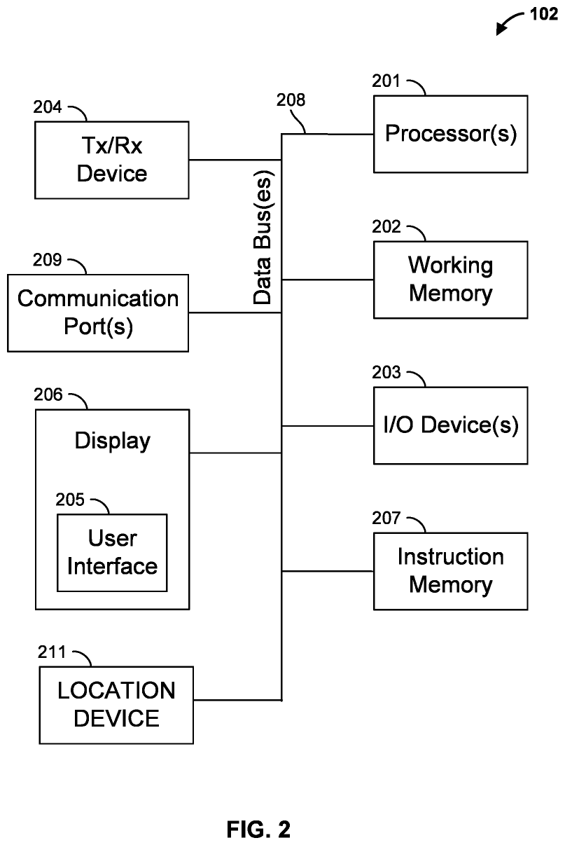

FIG. 2 illustrates a block diagram of an insight generation computing device, e.g. the insight generation computing device 102 of FIG. 1, in accordance with some embodiments of the present teaching. In some embodiments, each of the insight generation computing device 102, the server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the insight generation computing device 102 can be combined, omitted, and/or replicated. In addition, it will be appreciated that additional elements other than those illustrated in FIG. 2 can be added to the insight generation computing device 102.

As shown in FIG. 2, the insight generation computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the insight generation computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the insight generation computing device 102 can include a single memory unit configured to operate as both instruction memory and working memory. Further, although embodiments are discussed herein including non-volatile memory, it will be appreciated that the insight generation computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the insight generation computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the insight generation computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the insight generation computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the insight generation computing device 102 and/or the server 104. For example, the user interface 205 can be a user interface for an application of a network environment operator that allows a user to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the insight generation computing device 102 may determine a local geographical area (e.g., town, city, state, etc.) of its position.

In some embodiments, the insight generation computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

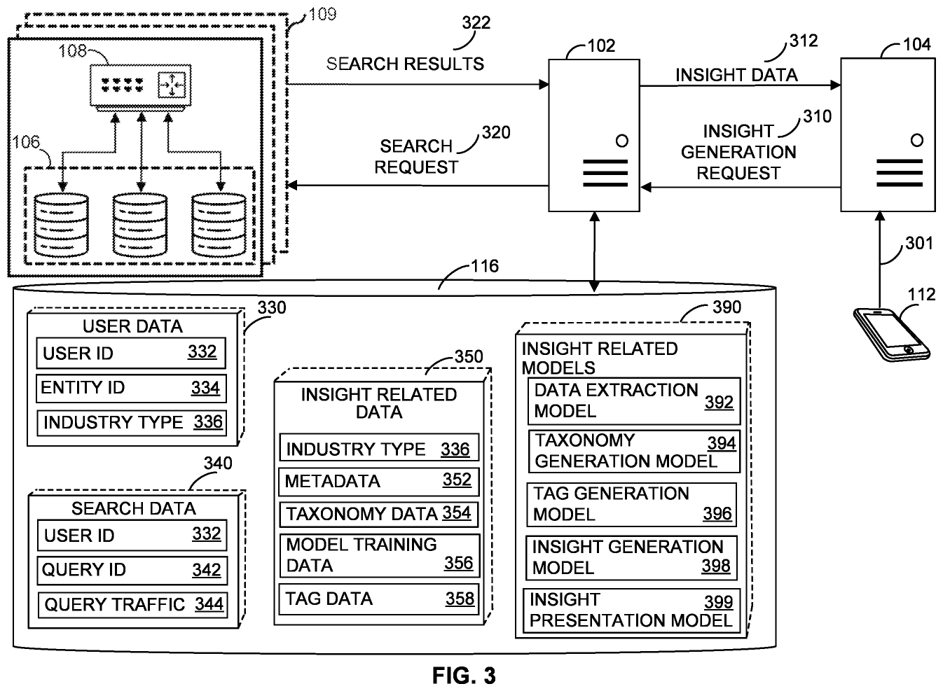

FIG. 3 is a block diagram illustrating various portions of a system for automatically generating and presenting structured insight data, e.g. the system shown in the network environment 100 of FIG. 1, in accordance with some embodiments. As discussed above, the insight generation computing device 102 may receive user session data from the server 104, and store the user session data in the database 116.

The insight generation computing device 102 may parse the user session data to generate user data 330 and search data 340. In this example, the user data 330 may include, for each user of the server 104, one or more of: a user identity (ID) 332 identifying the user, an entity ID 334 identifying an entity associated with the user, an industry type 336 identifying a type of industry associated with the entity or the user. The insight generation computing device 102 and/or the server 104 may store the user data 330 in the database 116.

The database 116 may also store the search data 340, which may identify one or more attributes of a plurality of queries submitted by users of the server 104. The search data 340 may include, for each of the plurality of queries, a query ID 342 identifying a query previously submitted by users, a query traffic 344 identifying how many times the query has been submitted and/or how many clicks the query has received, and the user ID 332 identifying users submitted the query.

The database 116 may also store insight related data 350, which may identify data related to insight generation of the insight generation computing device 102. The insight related data 350 may include: the industry type 336 identifying a type of industry associated with the entity or the user, metadata 352 identifying metadata extracted from documents in search results, taxonomy data 354 identifying taxonomies for each industry type or a user-specified configuration, model training data 356 including training data used to train one or more models for generating the insight data from the search results, and/or tag data 358 identifying tags applied to the documents in the search results based on the trained one or more models, e.g. the insight related models 390.

The database 116 may also store the insight related models 390 identifying and characterizing one or more models for automatically generating and presenting structured insight data. For example, the insight related models 390 may include a data extraction model 392, a taxonomy generation model 394, a tag generation model 396, an insight generation model 398, and an insight presentation model 399.

The data extraction model 392 may be used to extract textual data and/or metadata from a document in the search results. In some embodiments, the data extraction model 392 is based on optical character recognition (OCR) and natural language processing (NLP). For example, after OCR is applied to recognize textual information of the document, NLP can be applied to determine boundaries of the textual data meeting predetermined conditions or queries.

The taxonomy generation model 394 may be used to generate a set of taxonomies based on an industry type and/or user configuration related to a user request. For example, the taxonomy generation model 394 is used to generate different taxonomies according to different industry types of user requests. A different industry type corresponds to different types of documents and/or different concerned data in the documents of the search results. The taxonomy generation model 394 may map different sets of taxonomies to different industry types. In some examples, the taxonomy generation model 394 is used to generate taxonomies based on a user configuration specified in the user request, where the user configuration may identify concerned data lists or types in the search results. In some examples, the taxonomy generation model 394 is used to generate taxonomies based on both the industry type and the user configuration.

The tag generation model 396 may be used to generate tags to be applied to documents in the search results. In some examples, the tag generation model 396 is used to generate the tags based on the taxonomies generated using the taxonomy generation model 394. As such, the tags for a document are related to an industry type or user configuration associated with the request for this document.

The insight generation model 398 may be used to generate insight data for documents in the search results. In some examples, the insight generation model 398 is used to generate structured insight data based on the textual data, the metadata, and the plurality of tags. The insight presentation model 399 may be used to determine a presentation style for the generated insight data. The insight presentation model 399 may indicate: a type of user interface for displaying the insight data, content to be displayed together with the insight data in the user interface, layout of different content in the user interface, a document format for the insight data, etc.

In some embodiments, one or more of the data extraction model 392, the taxonomy generation model 394, the tag generation model 396, the insight generation model 398 and the insight presentation model 399 are machine learning models trained based on training data, e.g. the model training data 356. In some embodiments, the training data includes labelled data and feedback data.

As indicated in FIG. 3, the insight generation computing device 102 may receive from the server 104 an insight generation request 310 as a message 301 sent from the user device 112 to the server 104. The insight generation request 310 may be associated with an industry type or a user configuration of a user using the user device 112. In response to the insight generation request 310, the insight generation computing device 102 generates insight data 312 identifying insights of data concerned by the user, and transmits the insight data 312 to the server 104. In some embodiments, the insight generation request 310 may be associated with a set of lien documents related to a collateral interested by a lender. In response, the insight generation computing device 102 generates the insight data 312 identifying insights of the lien documents to help the lender to quickly understand the lien documents, and make actions or decisions based on the insights. For example, the lender may determine to approve the loan and file a new UCC to secure the collateral, or notify the borrower to address a conflicting lien. In other embodiments, the user may be the borrower, a merchant, a seller, a consumer, a business manager, or any other user desiring insights of some documents.

In some examples, based on the insight generation request 310, the insight generation computing device 102 may generate and transmit a search request 320 to the data center(s) 109, seeking documents matching a query included in the search request 320. The insight generation computing device 102 may receive and aggregate the search results 322 from the data center(s) 109 in response to the search request 320. Based on the insight related models 390, the insight generation computing device 102 may generate the insight data 312 based on the search results 322 automatically in desired formats.

In some embodiments, the insight generation computing device 102 may assign one or more of the above described operations to a different processing unit or virtual machine hosted by one or more processing devices 120. Further, the insight generation computing device 102 may obtain the outputs of the these assigned operations from the processing units, and generate the insight data 312 based on the outputs.

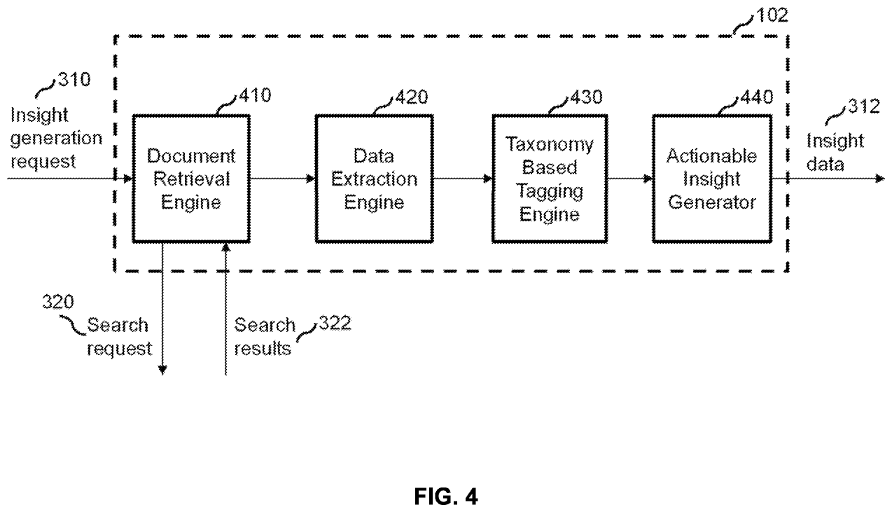

FIG. 4 shows a block diagram illustrating various portions of an insight generation computing device, e.g. the insight generation computing device 102 in FIGS. 1-3, in accordance with some embodiments of the present teaching. As shown in FIG. 4, the insight generation computing device 102 includes a document retrieval engine 410, a data extraction engine 420, a taxonomy based tagging engine 430, and an actionable insight generator 440. In some examples, one or more of the document retrieval engine 410, the data extraction engine 420, the taxonomy based tagging engine 430, and the actionable insight generator 440 are implemented in hardware. In some examples, one or more of the document retrieval engine 410, the data extraction engine 420, the taxonomy based tagging engine 430, and the actionable insight generator 440 are implemented as an executable program maintained in a tangible, non-transitory memory, such as instruction memory 207 of FIG. 2, which may be executed by one or processors, such as the processor 201 of FIG. 2.

For example, the document retrieval engine 410 may obtain the insight generation request 310 (e.g. from the server 104), and then send the search request 320 (e.g. to the data centers 109) based on the insight generation request 310. The insight generation request 310 may be generated for a user of the server 104. The search request 320 may indicate a search query, a set of conditions or an anchor document submitted by the user. In some embodiments, the document retrieval engine 410 receives the search results 322 from the data centers 109. The search results 322 include one or more documents matching the search query. In some embodiments, the document retrieval engine 410 includes a search engine or cooperates with a search engine at each of the data centers 109 to generate the search results 322. The document retrieval engine 410 forwards the search results 322 to the data extraction engine 420 for data extraction. In some embodiments, the document retrieval engine 410 may provide to the data extraction engine 420 other data related to the insight generation request 310, which may include the user data 330, the search data 340, and/or the insight related data 350 extracted from the database 116.

In one example, a lender may be interested in all liens granted over a collateral, and thus submit a request to search for lien documents related to the collateral. In this example, the insight generation request 310 is generated based on the lender's request and the search request 320 is sent to the data center(s) 109 including millions of UCC filings of lien documents. The search results 322 in this example include UCC-filed lien documents or active UCC filings related to the collateral.

In some embodiments, the data extraction engine 420 can obtain or collect various data with respect to the insight generation request 310, either from the document retrieval engine 410 or directly from the database 116. In some embodiments, the data extraction engine 420 extracts textual data and metadata from each document in the search results 322, e.g. based on the data extraction model 392. For example, the data extraction engine 420 can automatically extract the textual data and metadata using optical character recognition (OCR) and natural language processing (NLP), based on predetermined keywords or conditions. The keywords or conditions may be determined based on the industry type associated with the insight generation request 310 or a user configuration. The data extraction engine 420 then sends the extracted data to the taxonomy based tagging engine 430 for tagging.

In the above example of the lender, the data extraction engine 420 can extract, from the UCC documents, text and metadata including key information related to liens or the collateral. For example, the metadata may comprise information related to at least one of: a filing identity of each UCC document, a filing date of each UCC document, a UCC type of each UCC document, a debtor in each UCC document, a secured party in each UCC document, or other filing data of each UCC document. The extracted data can help to quickly identify insights on lending risk locked in lengthy collateral text descriptions in the UCC fillings of the search results 322.

The taxonomy based tagging engine 430 in this example can determine a set of taxonomies based on the insight generation request 310. For example, the taxonomy based tagging engine 430 can determine an industry type associated with the insight generation request 310; and determine a user configuration associated with the insight generation request 310. The set of taxonomies may be determined based on the industry type and/or the user configuration, e.g. using the taxonomy generation model 394. The taxonomy based tagging engine 430 can also generate a plurality of tags for each document in the search results 322 based on the set of taxonomies, e.g. using the tag generation model 396. The taxonomy based tagging engine 430 then sends the generated tags and other related data to the actionable insight generator 440 for insight data generation.

In the above example of the lender, the taxonomy based tagging engine 430 can determine a set of taxonomies related to the lien industry or loan industry. The plurality of tags generated can help to identify commonly concerned information of each UCC document in the search results 322 for the lien industry or loan industry, or user specified information for the user to quickly make a lending decision.

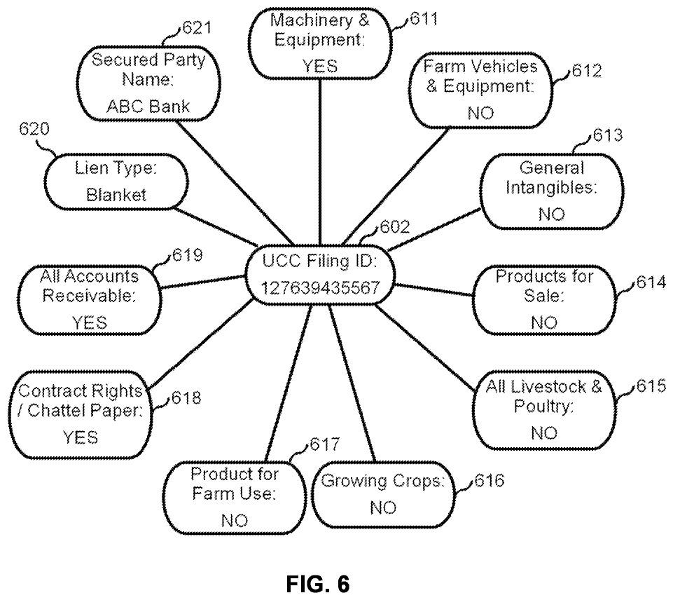

FIG. 6 illustrates exemplary tags that can be output as insight data, in accordance with some embodiments. As shown in FIG. 6, for a UCC document with a UCC filing ID 602, a plurality of tags are generated and listed. In this example, for the document with UCC filing ID 602 of 127639435567, the plurality of tags comprises: a tag 611 identifying whether the collateral is machinery or equipment, a tag 612 identifying whether the collateral is a vehicle or equipment used at a farm, a tag 613 identifying whether the collateral belongs to general intangible items, a tag 614 identifying whether the collateral is a product for sale, a tag 615 identifying whether the collateral belongs to livestock and poultry, a tag 616 identifying whether the collateral belongs to growing crops, a tag 617 identifying whether the collateral is a product for farm use, a tag 618 identifying whether the lien document includes contract rights or chattel paper for the collateral, a tag 619 identifying whether all accounts associated with the lien document are receivable, a tag 620 identifying a lien type of the lien document, a tag 621 identifying a secured party name in the lien document. In some embodiments, the tags generated for the lien document may also include a tag identifying whether the lien document includes a change in the collateral, and if so, the changing dates and other related changing data.

Referring back to FIG. 4, the actionable insight generator 440 in the insight generation computing device 102 can generate structured insight data based on the textual data and the metadata extracted by the data extraction engine 420, and the plurality of tags generated by the taxonomy based tagging engine 430. The actionable insight generator 440 transmits the structured insight data 312 to the user, e.g. via the server 104 and/or an API. In some embodiments, the structured insight data 312 is transmitted in a document format determined based on the insight generation request 310, a user configuration, or a predetermined configuration for the API.

As such, the insight generation computing device 102 can convert unstructured raw data in documents to structured insight data using AI models, and transform data into actionable intelligence by combining extracted metadata and user configured tagging taxonomies. This will enable high confidence and low risk decision-making by providing intelligent insight data to users. In some embodiments, the structured insight data 312 is transmitted in a document format that can be directly read or processed by a system on the user side.

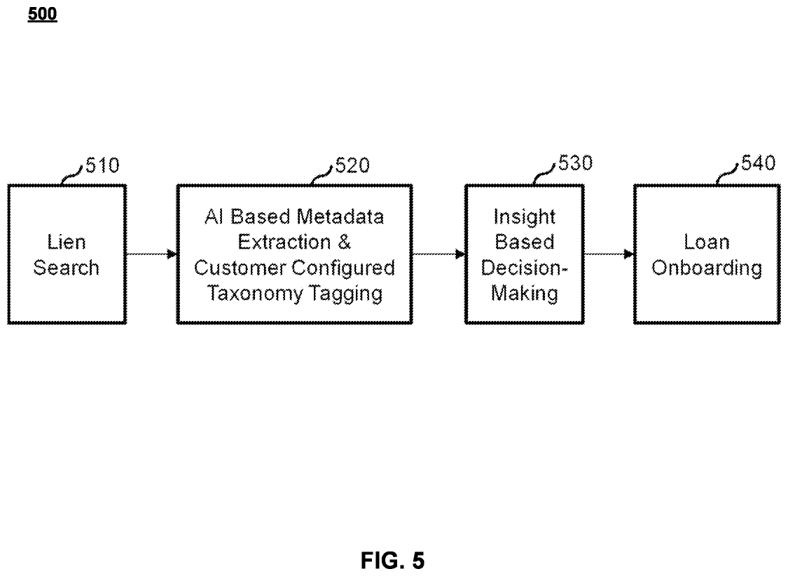

FIG. 5 illustrates a process 500 for securing a loan based on a lien search, in accordance with some embodiments. In some embodiments, the process 500 can be carried out by one or more computing devices, such as the server 104 and/or the insight generation computing device 102 of FIG. 1.

As shown in FIG. 5, the process 500 starts from operation 510, where a lien search is performed, e.g. based on a query identifying a collateral of the loan. In some embodiments, the lien search is performed on all UCC filings across different states and time.

At operation 520, an AI-based automated workflow is performed to extract textual data, metadata from the searched UCC filings, and apply tags to the searched UCC filings based on user configured taxonomies (or industry-based taxonomies). In some embodiments, the taxonomies include a first set of taxonomies at the level of collateral, and a second set of taxonomies at the level of complete UCC filing. These insight data are delivered in an API based format or user specified format to the user.

At operation 530, the user (e.g. a lender) can make a decision based on the insight data. At operation 540, an onboarding process for the loan may be performed to secure the loan, upon a determination by the lender. For example, the lender can file a UCC lien to secure claim on the collateral and manage the UCC lien to ensure ongoing protection.

The automated workflow at the operation 520 uses AI models or machine learning models to reduce risk in critical lending decisions and deliver intelligence at scale such that lenders have confidence in their decisions. The AI models used in the disclosed system have overcome many challenges caused by non-uniformity of the UCC forms across states and time, historical changes of lien documents, etc.

First, many UCC filings have a poor image quality, with no clear boundary defined for different fields. In addition, metadata, collateral descriptions, and filing details may be distributed across different locations (e.g. UCC forms, Schedule A, Addendums, Exhibits, etc.) of lien documents. Even a same content may be in different locations or sections of different documents. The AI models are trained to extract concerned text from all possible locations of lien documents, and using OCR and NLP to extract accurate texts from poor imaged documents.

Second, pages of a lien document are often not in correct sequence when being retrieved from a database. In some examples, overlapping pages are generated when the document was scanned into the database. The AI models are trained to extract data and generate tags for documents, independent of the sequence of the pages in the documents and cognizant of any possible overlapping pages.

Third, original and amended UCC documents can use the same filing number and should be grouped into families. The AI models are trained to tag the documents to catch changes in collateral, debtors, and secured parties as original UCC documents are amended over time, to ensure the amendments are seen all together.

Further, many insight data like whether a lien is a blanket lien or not, cannot be directly extracted from a lien document. The AI models are trained to generate a score evaluating a probability whether a lien is blanket, based on and textual and contextual information of the lien document. The lien is tagged as blanket when the score is larger than a predetermined threshold. In some embodiments, the AI models are trained with training data including qualifying phrases indicating a lien is blanket and negative phrases indicating a lien is not blanket.

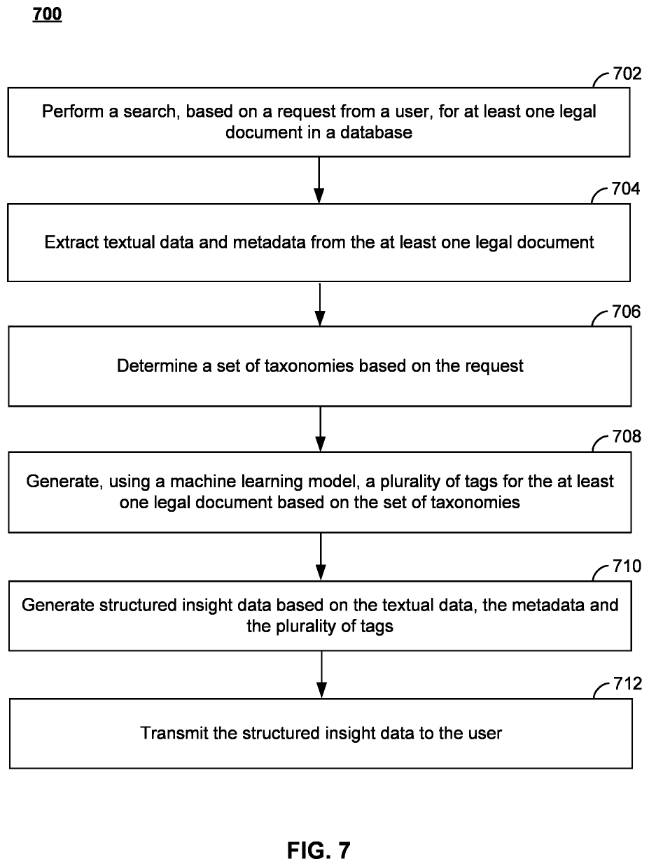

FIG. 7 is a flowchart illustrating an exemplary method 700 for automatically generating and presenting structured insight data, in accordance with some embodiments of the present teaching. In some embodiments, the method 700 can be carried out by one or more computing devices, such as the insight generation computing device 102 and/or the cloud-based engine 121 of FIG. 1. Beginning at operation 702, a search is performed based on a request from a user for at least one legal document in a database. At operation 704, textual data and metadata are extracted from the at least one legal document. At operation 706, a set of taxonomies are determined based on the request. At operation 708, using a machine learning model, a plurality of tags are generated for the at least one legal document based on the set of taxonomies. At operation 710, structured insight data is generated based on the textual data, the metadata and the plurality of tags. At operation 712, the structured insight data is transmitted to the user.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system for automated data extraction and analysis in financial due diligence, comprising:
a non-transitory memory having instructions stored thereon; and
at least one processor communicatively coupled to the non-transitory memory, and configured to read the instructions to:
receive a search request from a user device, wherein the search request is directed to a domain-specific database;
search the domain-specific database based on the search request to identify at least one domain-specific document;
apply a natural language processing (NLP) model to extract textual data and metadata from the at least one domain-specific document;
provide the textual data and the metadata as inputs to at least one insight related machine learning model;
generate, via the insight related machine learning model, structured insight data based on a set of taxonomies; and
transmit, to the user device, instructions configured to cause the user device to display the structured insight data to the user.

2. The system of claim 1, wherein the insight related machine learning model comprises at least one of a data extraction model, a taxonomy generation model, a tag generation model, an insight generation model, and an insight presentation model.

3. The system of claim 1, wherein the at least one domain-specific document is related to a lien granted over a collateral.

4. The system of claim 3, wherein the insight related machine learning model is configured to generate a plurality of tags for the at least one domain-specific document based on the set of taxonomies, and wherein the structured insight data is generated based on a categorization of the textual data and the metadata using the plurality of tags.

5. The system of claim 4, wherein the plurality of tags comprises tags related to a property of the collateral.

6. The system of claim 1, wherein the NLP model is configured to:
scan the at least one domain-specific document; and
apply optical character recognition (OCR) to extract the textual data and metadata relevant to the request.

7. The system of claim 1, wherein the set of taxonomies are determined based on an industry associated with the search request, a user configuration associated with the search request, or a combination thereof.

8. The system of claim 1, wherein the insight related machine learning model is trained based on labelled data and feedback data.

9. A computer-implemented method for automated data extraction and analysis in financial due diligence, comprising:
receiving a search request from a user device, wherein the search request is directed to a domain-specific database;
searching the domain-specific database based on the search request to identify at least one domain-specific document;
applying a natural language processing (NLP) model to extract textual data and metadata from the at least one domain-specific document;
providing the textual data and the metadata as inputs to at least one insight related machine learning model;
generating, via the insight related machine learning model, structured insight data based on a set of taxonomies; and
transmitting, to the user device, instructions configured to cause the user device to display the structured insight data to the user.

10. The computer-implemented method of claim 9, wherein the insight related machine learning model comprises at least one of a data extraction model, a taxonomy generation model, a tag generation model, an insight generation model, and an insight presentation model.

11. The computer-implemented method of claim 9, wherein the at least one domain-specific document is related to a lien granted over a collateral.

12. The computer-implemented method of claim 11, wherein the insight related machine learning model is configured to generate a plurality of tags for the at least one domain-specific document based on the set of taxonomies, and wherein the structured insight data is generated based on a categorization of the textual data and the metadata using the plurality of tags.

13. The computer-implemented method of claim 12, wherein the plurality of tags comprises tags related to a property of the collateral.

14. The computer-implemented method of claim 9, wherein the NLP model is configured to:
scan the at least one domain-specific document; and
apply optical character recognition (OCR) to extract the textual data and metadata relevant to the request.

15. The computer-implemented method of claim 9, wherein the set of taxonomies are determined based on an industry associated with the search request, a user configuration associated with the search request, or a combination thereof.

16. computer-implemented method of claim 9, wherein the insight related machine learning model is trained based on labelled data and feedback data.

17. A non-transitory computer readable medium having instructions stored thereon, wherein the instructions, when executed by at least one processor, cause at least one device to perform operations comprising:
receiving a search request from a user device, wherein the search request is directed to a domain-specific database;
searching the domain-specific database based on the search request to identify at least one domain-specific document;
applying a natural language processing (NLP) model to extract textual data and metadata from the at least one domain-specific document;
providing the textual data and the metadata as inputs to at least one insight related machine learning model;
generating, via the insight related machine learning model, structured insight data based on a set of taxonomies; and
transmitting, to the user device, instructions configured to cause the user device to display the structured insight data to the user.

18. The non-transitory computer readable medium of claim 17, wherein the at least one domain-specific document is related to a lien granted over a collateral.

19. The non-transitory computer readable medium of claim 17, wherein the insight related machine learning model comprises at least one of a data extraction model, a taxonomy generation model, a tag generation model, an insight generation model, and an insight presentation model.

20. The non-transitory computer readable medium of claim 17, wherein the NLP model is configured to:
scan the at least one domain-specific document; and
apply optical character recognition (OCR) to extract the textual data and metadata relevant to the request.
